(19) United States
(12) Patent Application Publication
(10) Pub. No.: US 2019/0120152 A1
(43) Pub. Date: Apr. 25, 2019

(54) FUEL REFORMING SYSTEM AND CONTROL METHOD OF EXHAUST GAS SUPPLY

(71) Applicants: Hyundai Motor Company, Seoul (KR); Kia Motors Corporation, Seoul (KR)

(72) Inventors: Hong Kil Baek, Seoul (KR); Seung Woo Lee, Seoul (KR); Tae Won Lee, Incheon (KR)

(21) Appl. No.: 15/818,240

(22) Filed: Nov. 20, 2017

(30) Foreign Application Priority Data
Oct. 25, 2017 (KR) 10-2017-0139146

(51) Int. Cl. F02D 41/00; F02D 41/02; F02M 26/36

(52) U.S. Cl. CPC F02D 41/0055; F02M 26/30; F02M 26/36; F02D 41/024

(57) ABSTRACT

A fuel reforming system is provided. The system includes an engine combusting reformed gas to generate mechanical power and an intake line connected with the engine to supply the reformed gas and air to the engine. An exhaust line is connected with the engine to circulate exhaust gas and a fuel reformer disposed at an exhaust gas recirculation (EGR) line diverging from the exhaust line mixes the exhaust gas passing through the EGR line with fuel and reforms the mixed fuel. An exhaust gas purifying catalyst disposed at the exhaust line purifies nitrogen oxide in the exhaust gas. A temperature sensor at the exhaust line of the exhaust gas purifying catalyst measures temperature of the exhaust gas purifying catalyst. A bypass controller then operates a bypass valve to supply or cut off the exhaust gas into the fuel reformer according to temperature of the exhaust gas purifying catalyst.

### CROSS-REFERENCE TO RELATED APPLICATION

This application claims priority to and the benefit of Korean Patent Application No. 10-2017-0139146 filed on Oct. 25, 2017, the entire contents of which are incorporated herein by reference.

### BACKGROUND

### (a) Field of the Invention

The present invention relates to a fuel reforming system and control method of exhaust gas supply, and more particularly, to a fuel reforming system and control method of exhaust gas supply which supplies or cuts off exhaust gas to a fuel reformer based on a temperature of exhaust gas purifying catalyst.

### (b) Description of the Related Art

Hydrogen has physical and chemical characteristic of about six times of laminar flame velocity and about three times of lower heating value compared with gasoline. Accordingly, during combusting by properly mixing gasoline and hydrogen, combustion speed and combustion stability may be increased to improve thermal efficiency by expanding lean boundary or increasing supply amount of exhaust gas recirculation.

Meanwhile, a fuel reformer is a system that generates hydrogen. In particular, the hydrogen is generated by reacting separate gasoline fuel supplied to the reformer with a catalyst in the reformer using thermal energy of high temperature exhaust gas exhausted from an engine. Accordingly, when supply amount of exhaust gas recirculation (EGR) and fuel reforming gas is controlled, the exhaust gas is supplied to the exhaust gas purifying catalyst and the fuel reformer during cold starting, therefore exhaust gas energy supplied to the exhaust gas purifying catalyst is decreased. Accordingly, activation time of the exhaust gas purifying catalyst becomes delayed and performance of the exhaust gas purification is deteriorated.

The above information disclosed in this section is merely for enhancement of understanding of the background of the invention and therefore it may contain information that does not form the prior art that is already known in this country to a person of ordinary skill in the art.

### SUMMARY

The present invention provides a fuel reforming system and control method of exhaust gas supply which may supply the exhaust gas to the exhaust gas purifying catalyst during cold starting and supply the exhaust gas to the exhaust gas purifying catalyst and the fuel reformer after activation of the exhaust gas purifying catalyst.

A fuel reforming system according to an exemplary embodiment of the present invention may include an engine configured to combust reformed gas to generate mechanical power; an intake line connected with the engine to supply the reformed gas and air to the engine; an exhaust line connected with the engine to circulate exhaust gas exhausted from the engine; a fuel reformer disposed at an exhaust gas recirculation (EGR) line that diverges from the exhaust line, mixes the exhaust gas passing through the EGR line with fuel and reforms the fuel mixed with the exhaust gas; an exhaust gas purifying catalyst disposed at the exhaust line and configured to purify nitrogen oxide included in the exhaust gas; a temperature sensor disposed at the exhaust line at a front end of the exhaust gas purifying catalyst and configured to measure or detect temperature of the exhaust gas purifying catalyst; and a bypass controller configured to operate a bypass valve to supply or cut off the exhaust gas into the fuel reformer based on temperature of the exhaust gas purifying catalyst measured by the temperature sensor.

The bypass valve may be disposed at the exhaust line from which the EGR line diverges. The bypass valve controller may be configured to operate the bypass valve to supply the exhaust gas to the fuel reformer when temperature of the exhaust gas purifying catalyst is greater than catalyst activation temperature. The bypass valve controller may be configured to operate the bypass valve to cut off the exhaust gas into the fuel reformer when temperature of the exhaust gas purifying catalyst is less than the catalyst activation temperature. The catalyst activation temperature may be about 350 degrees Celsius.

The bypass valve may include a valve housing, an opening and closing member disposed in the valve housing and configured to supply or cut off the exhaust gas into the fuel reformer, and a hinge shaft that rotates the opening and closing member by a structure in which a first end is supported on the opening and closing member and a second end rotates in the valve housing.

Meanwhile, a fuel reforming system according to an exemplary embodiment of the present invention may further include a compressor connected with the intake line and configured to compress and supply the reformed gas and air to the engine; and a turbine connected with the exhaust line and rotated by the exhaust gas to generate power. An EGR cooler configured to cool the reformed gas and an EGR valve disposed at a rear end of the EGR cooler and adjust flow rate of the reformed gas may be installed at the EGR line. The fuel reformer may be installed at a front portion of the EGR cooler in the EGR line.

Meanwhile, a control method of exhaust gas supply according to an exemplary embodiment of the present invention is a control method of exhaust gas supply of a fuel reforming system that may include a fuel reformer configured to mix the EGR gas passing through the EGR line with the fuel and reform the fuel mixed in the EGR gas and an exhaust gas purifying catalyst configured to purify nitrogen oxide included in the exhaust gas, and may include detecting, by a temperature sensor, temperature of the exhaust gas purifying catalyst; determining, by a controller, whether the temperature of the exhaust gas purifying catalyst is greater than catalyst activation temperature; supplying, by a controller, the exhaust gas to the fuel reformer by opening a bypass valve of the fuel reforming system when temperature of the exhaust gas purifying catalyst is greater than catalyst activation temperature; and cutting off, by a controller, the exhaust gas into the fuel reformer by closing the bypass valve of the fuel reforming system when temperature of the exhaust gas purifying catalyst is less than the catalyst activation temperature. The catalyst activation temperature is about 350 degrees Celsius.

According to an exemplary embodiment of the present invention, in a low speed/low torque driving condition which the exhaust gas temperature is low, performance deterioration of the exhaust gas purifying catalyst may be prevented by cutting off the exhaust gas into the fuel reformer. Additionally, in a high speed/high torque driving condition which the exhaust gas temperature is high, exhaust gas purifying performance may be improved by supplying the exhaust gas into the fuel reformer.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view illustrating a fuel reforming system according to an exemplary embodiment of the present invention;

FIG. 2 is a schematic view illustrating a bypass valve according to an exemplary embodiment of the present invention; and

FIG. 3 is a flowchart illustrating a control method of exhaust gas supply of a fuel reforming system according to an exemplary embodiment of the present invention.

### DESCRIPTION OF SYMBOLS

5: intake line

6: compressor

7: turbine

8: intercooler

9: throttle valve

10: engine

15: exhaust line

17: EGR line

20: fuel reformer

25: temperature sensor

30: exhaust gas purifying catalyst

32: exhaust gas pressure control valve

50: EGR cooler

60: EGR valve

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described more fully with reference to the accompanying drawings, in which exemplary embodiments of the invention are shown. As those skilled in the art would realize, the described exemplary embodiments may be modified in various different ways, all without departing from the spirit or scope of the present invention.

Further, in exemplary embodiments, since like reference numerals designate like elements having the same configuration, a first exemplary embodiment is representatively described, and in other exemplary embodiments, only configurations different from the first exemplary embodiment will be described.

The drawings are schematic, and are not illustrated in accordance with a scale. Relative dimensions and ratios of portions in the drawings are illustrated to be exaggerated or reduced in size for clarity and convenience, and the dimensions are just exemplified and are not limiting. In addition, same structures, elements, or components illustrated in two or more drawings use same reference numerals for showing similar features. It will be understood that when an element such as a layer, film, region, or substrate is referred to as being “on” another element, it can be directly on the other element or intervening elements may also be present.

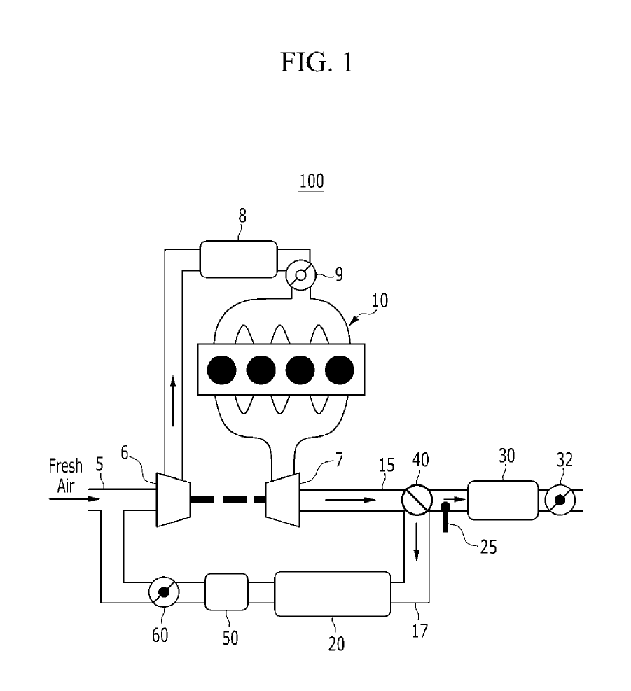

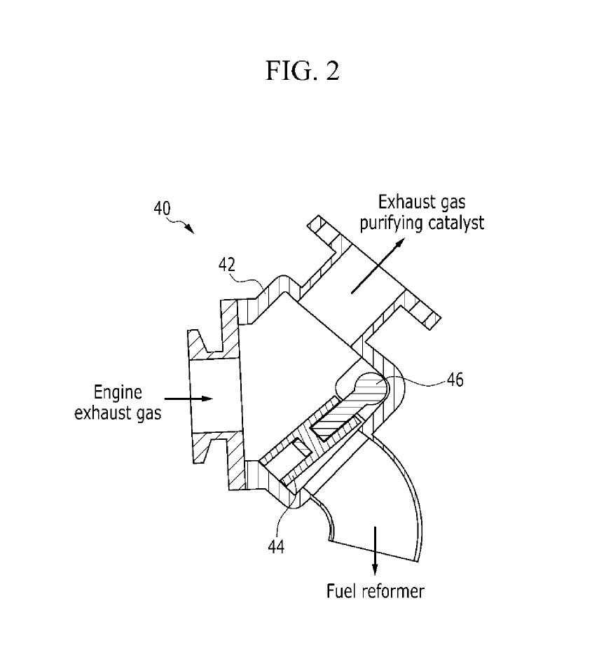

The exemplary embodiment of the present invention shows an exemplary embodiment of the present invention in detail. As a result, various modifications of the drawings will be expected. Therefore, the exemplary embodiment is not limited to a specific aspect of the illustrated region, and for example, includes modifications of an aspect by manufacturing. Now, a fuel reforming system according to an exemplary embodiment of the present invention will be described with reference to FIG. 1 and FIG. 2.

FIG. 1 is a schematic view illustrating a fuel reforming system according to an exemplary embodiment of the present invention, and FIG. 2 is a schematic view illustrating a bypass valve according to an exemplary embodiment of the present invention. Referring to FIG. 1, a fuel reforming system 100 may include an engine 10, an intake line 5, an exhaust line 15, a fuel reformer 20, an exhaust gas purifying catalyst 30, a temperature sensor 25, and a bypass valve controller (not illustrated).

The engine 10 burns air/fuel mixture in which fuel and air are mixed to convert chemical energy into mechanical energy. The engine 10 is connected to an intake manifold to receive the air in a combustion chamber, and is connected to an exhaust manifold to gather exhaust gas generated in combustion process in the exhaust manifold and to exhaust the gas to the exterior. An injector may be mounted in the combustion chamber to inject the fuel into the combustion chamber. The intake line 5 may be connected with entrance of the engine 10 to supply reformed gas and air to the engine 10, and the exhaust line 15 may be connected with exit of the engine 10 to circulate exhaust gas exhausted from the engine 10.

A portion of the exhaust gas exhausted from the engine may be supplied to the engine 10 through the EGR line 17. In addition, the EGR line 17 may be connected with the intake manifold of the engine 10 to adjust combustion temperature by mixing a portion of the exhaust gas with air. This combust temperature control may be conducted by adjusting exhaust gas amount supplied to the intake manifold. Accordingly, EGR valve 60 configured to adjust flow rate of the reformed gas may be installed at the EGR line 17.

An exhaust gas recirculation system realized by the EGR line 17 may be configured to supply a portion of the exhaust gas to the intake system and inflow a portion of the exhaust gas to combustion chamber when exhaust amount of the nitrogen oxide needs to be reduced according to driving condition. Further, the exhaust gas that is inert gas volume of which remains the same depresses density of the air/fuel mixture and flame transmitting speed is reduced during combustion of the fuel. Therefore, combustion velocity of the fuel is reduced and raise of the combustion temperature is reduced to depress generation of the nitrogen oxide.

The fuel reformer 20 may be disposed at the EGR line 17 diverging from the exhaust line 15 and may be configured to mix the exhaust gas that flows in from the EGR line 17 with fuel to reform the fuel mixed with the exhaust gas. The fuel reformer 20 may include an entrance into which the exhaust gas flows in (e.g., inflows), a mixing portion which the exhaust gas and fuel are mixed, a reforming portion reforming the fuel, and an exit or output from which the exhaust gas is exhausted (e.g., flows out of).

An EGR cooler 50 configured to cool reformed gas passing through the engine 10 and the fuel reformer 20 may be provided at the EGR line 17. The EGR cooler 50 may be disposed at a rear end of the fuel reformer 20 and integrally provided with the fuel reformer 20. The exhaust gas purifying catalyst 30 may include a lean NOx trap (LNT) which traps the nitrogen oxide included in the exhaust gas in a lean condition and desorbs the trapped nitrogen in a rich condition, and restores the nitrogen oxide included in the exhaust gas or the desorbed nitrogen oxide. The LNT may oxidize carbon monoxide (CO) and hydrocarbon (HC) included in the exhaust gas. In particular, it should be understood that the hydrocarbon is used to imply compound including carbon and hydrogen in exhaust gas and fuel.

Additionally, the exhaust gas purifying catalyst 30 may include a selective catalytic reducer (SCR) configured to restore the nitrogen oxide included in the exhaust gas using reducing agent. The reducing agent may be urea injected from an injection module. An exhaust gas pressure control valve 32 configured to adjust flow rate of the exhaust gas may be disposed at the exhaust line 15 at a rear end of the exhaust gas purifying catalyst 30. The temperature sensor 25 may be disposed at the exhaust line 15 at a front end of the exhaust gas purifying catalyst 30 and may be configured to measure or detect temperature of the exhaust gas purifying catalyst 30.

The bypass controller (not illustrated) may be configured to operate a bypass valve 40 to supply or cut off the exhaust gas into the fuel reformer 20 based on the temperature of the exhaust gas purifying catalyst 30 measured by the temperature sensor 25. The bypass valve 40 may be disposed at the exhaust line 15 from which the EGR line 17 diverges. The bypass valve controller may be configured to operate the bypass valve 40 to supply the exhaust gas to the fuel reformer 20 when temperature of the exhaust gas purifying catalyst 30 is greater than catalyst activation temperature. Additionally, the bypass valve controller may be configured to operate the bypass valve 40 to cut off the exhaust gas from the fuel reformer 20 when temperature of the exhaust gas purifying catalyst 30 is less than the catalyst activation temperature. At this time, the catalyst activation temperature may be about 350 degrees Celsius.

Referring to FIG. 2, the bypass valve 40 may include a valve housing 42, an opening and closing member 44 disposed in the valve housing 42 and configured to supply or cut off the exhaust gas into the fuel reformer 20, and a hinge shaft 46 that rotates the opening and closing member 44 by a structure in which a first end is supported on the opening and closing member 44 and a second end rotates in the valve housing 42.

Meanwhile, the fuel reforming system 100 according to an exemplary embodiment of the present invention may further include a compressor 6 connected with the intake line 5 and configured to compress and supply the reformed gas and air to the engine 10, and a turbine 7 connected with the exhaust line 15 and configured to rotate by the exhaust gas to generate power. Additionally, the reforming system may include an intercooler 8 connected with the compressor 6 and configured to cool air and reformed gas flowed into the intake line 5 of the engine 10 again, and a throttle valve 9 configured to adjust flow rate of the air and reformed gas.

Meanwhile, an EGR cooler 50 configured to cool the reformed gas and an EGR valve 60 disposed at a rear end of the EGR cooler 50 and configured to adjust flow rate of the reformed gas may be installed at the EGR line 17. The fuel reformer 20 may be disposed at a front portion of the EGR cooler 50 in the EGR line 17.

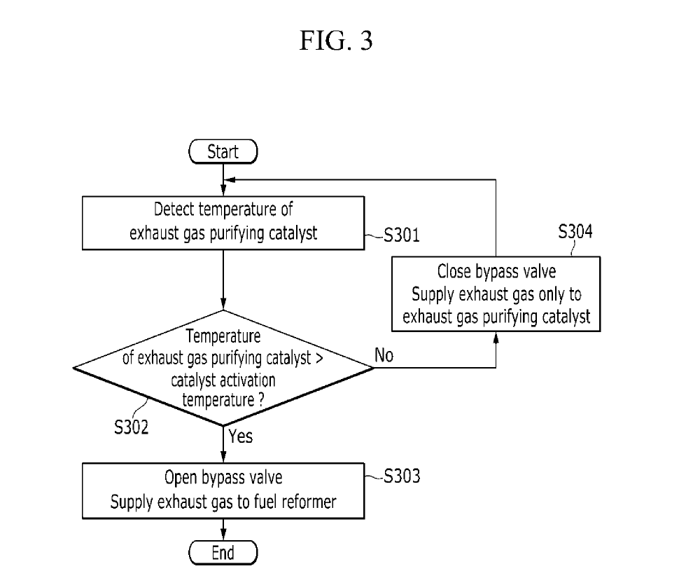

FIG. 3 is a flowchart illustrating a control method of exhaust gas supply of a fuel reforming system according to an exemplary embodiment of the present invention. Referring to FIG. 3, a control method of exhaust gas supply according to an exemplary embodiment of the present invention is a control method of exhaust gas supply of a fuel reforming system 100 including a fuel reformer 20 configured to mix the EGR gas passing through the EGR line 17 with the fuel and reforming the fuel mixed in the EGR gas and an exhaust gas purifying catalyst 30 configured to purify nitrogen oxide included in the exhaust gas.

Firstly, temperature of the exhaust gas purifying catalyst 30 may be detected by a temperature sensor 25 disposed at the exhaust line 15 at a front end of the exhaust gas purifying catalyst 30 S301. Further, whether the temperature of the exhaust gas purifying catalyst 30 is greater than catalyst activation temperature is determined S302. When temperature of the exhaust gas purifying catalyst 30 is greater than catalyst activation temperature, the exhaust gas may be supplied to the fuel reformer 20 by opening a bypass valve 40 of the fuel reforming system 100 S303. Then, when temperature of the exhaust gas purifying catalyst 30 is less than the catalyst activation temperature, the exhaust gas may be cut off into the fuel reformer 20 by closing the bypass valve 40 of the fuel reforming system 100 S304. The catalyst activation temperature may be about 350 degrees Celsius.

As describe above, in a low speed/low torque driving condition which the exhaust gas temperature is low, performance deterioration of the exhaust gas purifying catalyst may be prevented by cutting off the exhaust gas into the fuel reformer. Additionally, in a high speed/high torque driving condition which the exhaust gas temperature is high, exhaust gas purifying performance may be improved by supplying the exhaust gas into the fuel reformer.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

What is claimed is:

1. A fuel reforming system, comprising:
an engine configured to combust reformed gas to generate mechanical power;
an intake line connected with the engine to supply the reformed gas and air to the engine;
an exhaust line connected with the engine to circulate exhaust gas exhausted from the engine;
a fuel reformer disposed at an exhaust gas recirculation (EGR) line that diverges from the exhaust line, and configured to mix the exhaust gas passing through the EGR line with fuel and reform the fuel mixed with the exhaust gas;
an exhaust gas purifying catalyst disposed at the exhaust line and configured to purify nitrogen oxide included in the exhaust gas;
a temperature sensor disposed at the exhaust line at a front end of the exhaust gas purifying catalyst and configured to measure temperature of the exhaust gas purifying catalyst; and
a bypass controller configured to operate a bypass valve to supply or cut off the exhaust gas into the fuel reformer based on temperature of the exhaust gas purifying catalyst measured by the temperature sensor.

2. The fuel reforming system of claim 1, wherein the bypass valve is disposed at the exhaust line from which the EGR line diverges.

3. The fuel reforming system of claim 2, wherein the bypass valve controller is configured to operate the bypass valve to supply the exhaust gas to the fuel reformer when temperature of the exhaust gas purifying catalyst is greater than catalyst activation temperature.

4. The fuel reforming system of claim 3, wherein the bypass valve controller is configured to operate the bypass valve to cutoff the exhaust gas from the fuel reformer when temperature of the exhaust gas purifying catalyst is less than the catalyst activation temperature.

5. The fuel reforming system of claim 4, wherein the catalyst activation temperature is about 350 degrees Celsius.

6. The fuel reforming system of claim 1, wherein the bypass valve includes:
a valve housing;
an opening and closing member disposed in the valve housing and configured to supply or cut off the exhaust gas into the fuel reformer; and
a hinge shaft configured to rotate the opening and closing member by a structure in which a first end is supported on the opening and closing member and a second end rotates in the valve housing.

7. The fuel reforming system of claim 1, further comprising:
a compressor connected with the intake line and configured to compress and supply the reformed gas and air to the engine; and
a turbine connected with the exhaust line and rotated by the exhaust gas to generate power.

8. The fuel reforming system of claim 1, wherein an EGR cooler configured to cool the reformed gas and an EGR valve disposed at a rear end of the EGR cooler and configured to adjust flow rate of the reformed gas are installed at the EGR line.

9. The fuel reforming system of claim 7, wherein the fuel reformer is installed at a front portion of the EGR cooler in the EGR line.

10. A control method of exhaust gas supply of a fuel reforming system including a fuel reformer configured to mix the EGR gas passing through the EGR line with the fuel and reform the fuel mixed in the EGR gas and an exhaust gas purifying catalyst configured to purify nitrogen oxide included in the exhaust gas, comprising,
detecting, by a temperature sensor, temperature of the exhaust gas purifying catalyst;
determining, by a controller, whether the temperature of the exhaust gas purifying catalyst is greater than catalyst activation temperature;
supplying, by the controller, the exhaust gas to the fuel reformer by opening a bypass valve of the fuel reforming system when temperature of the exhaust gas purifying catalyst is greater than catalyst activation temperature; and
cutting off, by the controller, the exhaust gas into the fuel reformer by closing the bypass valve of the fuel reforming system when temperature of the exhaust gas purifying catalyst is less than the catalyst activation temperature.

11. The control method of claim 9, wherein the catalyst activation temperature is about 350 degrees Celsius.
